(19) United States
(12) Patent Application Publication
(10) Pub. No.: US 2009/0319096 A1
(43) Pub. Date: Dec. 24, 2009

(54) CONTROL AND MONITOR HETEROGENEOUS AUTONOMOUS TRANSPORT DEVICES

(75) Inventors: Brad W. Offer, Seattle, WA (US); Stefan R. Bieniawski, Seattle, WA (US); Gregory J. Clark, Seattle, WA (US); David Halaas, Buckley, WA (US); Emad W. Saad, Renton, WA (US); John L. Vian, Renton, WA (US); Kevin E. McEneaney, Auburn, WA (US); Paul E.R. Pigg, Seattle, WA (US)

Correspondence Address: LEE & HAYES, PLLC, 601 W. RIVERSIDE AVENUE, SUITE 1400, SPOKANE, WA, 99201, US

(73) Assignee: The Boeing Company, Chicago, IL (US)

(21) Appl. No.: 12/110,195

(22) Filed: Apr. 25, 2008

(51) Int. Cl. G06F 19/00; G06F 15/16

(52) U.S. Cl. 701/2; 709/203

(57) ABSTRACT

This disclosure is directed to methods, computer-readable media, and systems for controlling one or more uninhabited heterogeneous autonomous transport devices. Embodiments of the present invention advantageously reduce costs and improve efficiencies by providing capabilities for a computing device to be able to control and to monitor one or more heterogeneous autonomous transport devices. This occurs by generating a command signal from a computing device and transmitting the command signal to control on-board computing devices of one or more heterogeneous transport devices to execute requirements of a mission. Also, embodiments of the present invention provide ways to start-up, to send commands, and to shut down real or simulated heterogeneous autonomous transport devices.

### CROSS REFERENCE TO RELATED APPLICATIONS

This patent application is related to co-pending, commonly-owned U.S. patent application Ser. No. 11/459,617 entitled “Autonomous Vehicle Rapid Development Testbed Systems and Methods” filed on Jul. 24, 2006 under Attorney Docket No. BO1-0305US, which is incorporated herein by reference.

### FIELD OF THE INVENTION

The field of the present disclosure relates to systems and methods for controlling and monitoring one or more uninhabited heterogeneous autonomous transport devices, including air borne, water borne, wall borne, and land based transport devices.

### BACKGROUND

Transport devices typically require some type of control system. For example, a variety of transport devices requires a control system that enables a human operator to control movements of a transport device and enables a human operator to monitor the transport device over a desired course. Thus, each transport device requires at least a human operator to physically drive the transport device and a second operator to monitor the transport device from a computing device. Furthermore, the individual computing devices may only control or monitor a group of homogeneous transport devices, such as computing device(s) directed towards air borne transport devices and computing device(s) directed towards land based transport devices.

Although human operators may control and monitor an individual transport device, there is room for improvement. It is desirable to find ways to control and to monitor a large number of heterogeneous autonomous transport devices.

### SUMMARY

The present invention is directed to methods, computer-readable media, and systems for controlling one or more uninhabited heterogeneous autonomous transport devices. Embodiments of the present invention advantageously reduce costs and improve efficiencies by providing capabilities for a computing device to be able to control and to monitor one or more uninhabited heterogeneous autonomous transport devices including but not limited to, unmanned air borne, water borne, wall borne, and land based transport devices. Also, embodiments of the present invention provide ways to start-up, to send commands, and to shut down real or simulated heterogeneous autonomous transport devices.

In one embodiment, a method describes controlling one or more uninhabited heterogeneous transport devices. The method includes generating a command signal from a control computing device for the one or more heterogeneous transport devices based on capabilities of each transport device and requirements of a mission, and transmitting the command signal to control on-board computing devices of the one or more heterogeneous transport devices to execute the requirements of the mission. Furthermore, the method monitors operating and health information, and assesses a status and a health condition of the one or more heterogeneous transport devices.

In another embodiment, a computer-readable storage media includes computer-program instructions that are executable by a control computer, the instructions are configured to cause the control computer to perform operations such as generating a command signal for one or more uninhabited heterogeneous transport devices based on capabilities of each transport device and requirements of a mission, transmitting the command signal to control on-board computing devices of the one or more uninhabited heterogeneous transport devices to execute the requirements of the mission, and receiving feedback from the on-board computing devices of the one or more uninhabited heterogeneous transport devices in response to the command signal. Also, the computer instructions for controlling and monitoring the one or more uninhabited heterogeneous transport devices include an advantage of a fail-safe feature.

In another embodiment, a system for controlling and monitoring one or more uninhabited heterogeneous transport devices includes a control architecture. The control architecture is configured to generate a command signal from a control computing device for the one or more uninhabited heterogeneous transport devices based on capabilities of each transport device and requirements of a mission, configured to transmit the command signal to control on-board computing devices of the one or more uninhabited heterogeneous transport devices to execute the requirements of the mission, and configured to receive feedback from the on-board computing devices of the one or more uninhabited heterogeneous transport devices based on a response to the command signal. The system reduces the number of operators needed to control and to monitor the uninhabited heterogeneous transport devices.

The features, functions, and advantages that have been discussed above or will be discussed below can be achieved independently in various embodiments, or may be combined in yet other embodiments, further details of which can be seen with reference to the following description and drawings. By way of example and not limitation, the control and monitor of uninhabited heterogeneous autonomous transport devices method described herein may be applied in many contexts and environments. By way of example and not limitation, the control and monitor of uninhabited heterogeneous autonomous transport devices method may be implemented to support real and simulated transport devices, mission requirements, rescue missions, military operations such as surveillance, tracking, and area search, robotic operations such as ordinance disposal, remote exploration, and large-scale manufacturing inspection, repairing roads, snow removal activities, cleaning streets, and the like.

### BRIEF DESCRIPTION OF THE DRAWINGS

Embodiments of systems and methods in accordance with the teachings of the present disclosure are described in detail below with reference to the following drawings. As used herein, the term exemplary refers to an example and not necessarily an ideal.

FIG. 1 is a schematic view of an exemplary system for controlling and monitoring uninhabited heterogeneous transport devices in accordance with an embodiment of the invention;

FIG. 2 is a schematic view of an exemplary control architecture in accordance with an embodiment of the invention;

FIG. 3 is a schematic overview of an exemplary process in accordance with an embodiment of the invention;

FIG. 4 is a schematic view of an exemplary process in accordance with an embodiment of the invention;

FIG. 5 is a schematic view of an exemplary health and state graph view in accordance with an embodiment of the invention;

FIG. 6 is a schematic view of an exemplary health and state graph view in accordance with an embodiment of the invention;

FIG. 7 is a schematic view of an exemplary map view in accordance with an embodiment of the invention; and

FIG. 8 illustrates a block diagram of an exemplary operating computing environment for the control and monitor system of FIG. 1.

### DETAILED DESCRIPTION

### Overview

The present disclosure teaches methods and systems for controlling one or more uninhabited heterogeneous autonomous transport devices, and is shown and described in the context of reducing the number of operators and/or drivers needed. For example, a single computing device or several computing devices can be used to control and to monitor the uninhabited heterogeneous transport devices. This disclosure describes generating a command signal from a control computing device for the one or more uninhabited heterogeneous transport devices based on capabilities of each transport device and requirements of a mission; and transmitting the command signal to control on-board computing devices of the one or more uninhabited heterogeneous transport devices to execute the requirements of the mission. The method also includes simplifying and consolidating Command and Control and Health Monitoring (CCHM) functions of the uninhabited heterogeneous transport devices into a single control computing device. Thus, the method controls the one or more uninhabited heterogeneous transport devices, monitors operating and health information, and assesses a status and a health condition of the one or more uninhabited heterogeneous transport devices.

In another embodiment, a computer-readable storage media includes computer-program instructions that are executable by a control computer, the instructions are configured to cause the control computer to perform operations such as generating a command signal for one or more uninhabited heterogeneous transport devices based on capabilities of each transport device and requirements of a mission, transmitting the command signal to control on-board computing devices of the one or more uninhabited heterogeneous transport devices to execute the requirements of the mission, and receiving feedback from the on-board computing devices of the one or more uninhabited heterogeneous transport devices in response to the command signal. Also, the computing instructions will cause operations to shut down the one or more uninhabited heterogeneous transport devices if at least one representation occurs due to a failure alert, a control signal is invalid, a command fails, or a connection is not active to a client-side server. Thus, the computer instructions for controlling and monitoring the one or more uninhabited heterogeneous transport devices offer the advantage of a fail-safe feature.

In another embodiment, a system for controlling and monitoring one or more heterogeneous transport devices includes a control architecture. The control architecture is configured to generate a command signal from a control computing device for the one or more heterogeneous transport devices based on capabilities of each transport device and requirements of a mission, configured to transmit the command signal to control on-board computing devices of the one or more heterogeneous transport devices to execute the requirements of the mission; and configured to receive feedback from the on-board computing devices of the one or more heterogeneous transport devices based on a response to the command signal. Furthermore, the system may include a communication component configured to receive a position and an attitude from a position sensing system and a health monitoring component to receive a status and a health information. Therefore, the system reduces the number of operators needed to control and to monitor the transport devices.

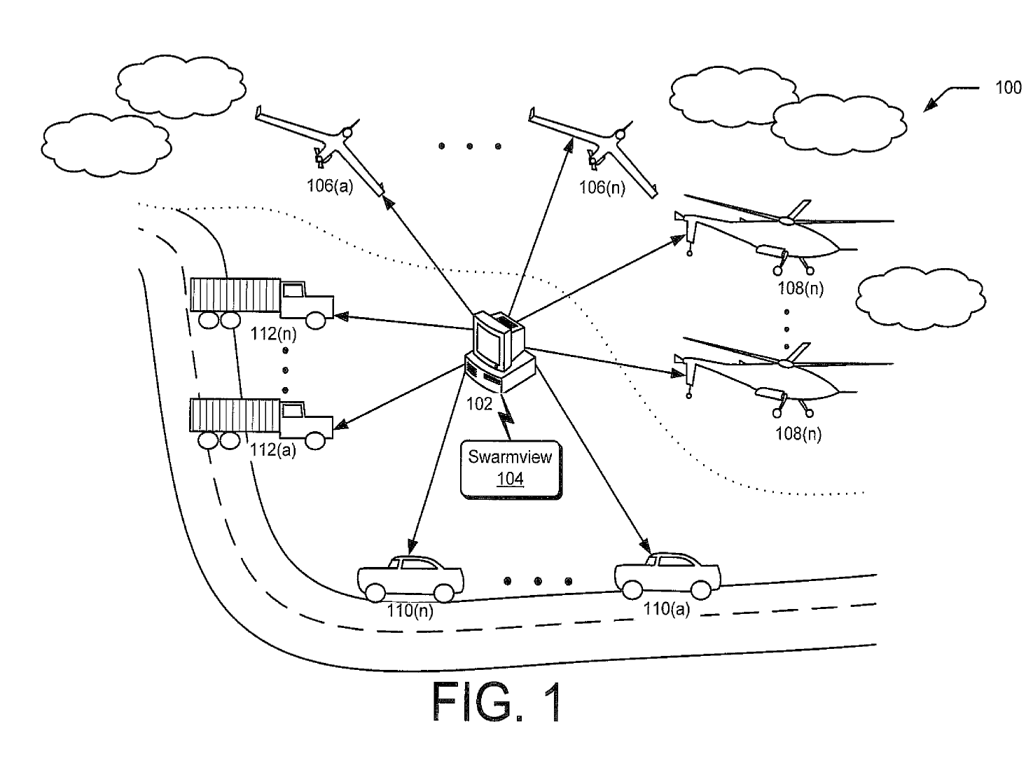

Many specific details of certain embodiments of the invention are set forth in the following description and in FIGS. 1-8 to provide a thorough understanding of such embodiments. One skilled in the art will understand, however, that the invention may have additional embodiments, or that the invention may be practiced without several of the details described in the following description.

### Exemplary Control and Monitor System

FIG. 1 illustrates a schematic view of an exemplary operating system 100 in accordance with one embodiment of the present invention. The operating system 100 is for controlling and monitoring one or more uninhabited heterogeneous autonomous transport devices in accordance with an embodiment of the invention. In this embodiment, the operating system 100 includes a control computing device 102 that is run by a human operator. The control computer 102 may include, but is not limited to a computing device, a desktop computer, a laptop computer, a handheld computing device, and the like. The control computer 102 may use an unique identifier to differentiate from other computing devices. For example, the control computer 102 may include but is not limited to, a number identification, an Internet Protocol (IP) address, and the like as the unique identifier. Furthermore, the human operator may log into the control computer 102 through a personal identification number, a password, a thumb print, a swipe of an employee badge, a voice activation, and the like.

The operating system 100 controls and monitors a large number of uninhabited heterogeneous autonomous transport devices as, for example, but not limited to, a tool, a method, a solver, software, an application program, a service, technology resources which include access to the internet, and the like. Here, controlling and monitoring uninhabited heterogeneous autonomous transport devices are implemented as an application program 104. In an embodiment, the application program is referred to as SwarmView 104 working operatively with the control computer 102.

Shown in FIG. 1 is a plurality of uninhabited heterogeneous autonomous transport devices that are operatively positioned to be controlled and monitored by SwarmView 104 during operation of the system 100. As shown in FIG. 1, the one or more uninhabited heterogeneous autonomous transport devices may include, but is not limited to, aircrafts, airplanes, flying devices with wings, 106(a) . . . 106(n), helicopters or flying devices without wings 108(a) . . . 108(n), automobiles 110(a) . . . 110(n), trucks 112(a) . . . 112(b), water borne such as submarines and ships, wall borne such as robotic wall climbers, land based, or any other suitable type of transport devices that are non-piloted or unmanned. SwarmView 104 helps control and monitors a large number of uninhabited heterogeneous autonomous transport devices in conjunction with a client-side server, on-board computing devices of the uninhabited heterogeneous transport devices, and a position sensing system. More details will be discussed later.

The control computing device 102 may include a communication device which means a device allowing an individual to interact with an electronic information system or the like. The system 100 may support one or more of the communication devices, which may transmit or receive data, text, video, audio, information, communication, and the like. The individual, an operator, is one that uses the control computing device 102 as a main form of communication with the transport devices.

In one embodiment, the control computer 102 operatively communicates through SwarmView 104 with the on-board computing device of each of the uninhabited heterogeneous transport devices through the client-side server via a communications link. The communications link may be a wireless link, a wire-based link, a fiber-optic link, or any other suitable type of communications link. Each communications link carries signals and data between the control computer 102 and the client-side server.

In operation, the control computer 102 via SwarmView 104 generates command signals to be transmitted to the one or more uninhabited heterogeneous autonomous transport devices 106, 108, 110, 112, directing the transport devices 106, 108, 110, 112 to perform desired missions, activities or functions. For example, an individual aircraft 106(a) may be directed to fly in a desired flight path and to collect desired information using an onboard sensor. Similarly, a aircraft 106(a), a helicopter 108(a), a automobile 110(a), and a truck 112(a) may be directed to traverse a desired ground path, collect information, or perform other desired activities. The uninhabited heterogeneous transport devices 106, 108, 110, 112 may be commanded to move independently of one another, or alternately, two or more of the uninhabited heterogeneous transport devices 106, 108, 110, 112 may be commanded to move in a coordinated manner, such as in flocking, or swarming movements.

Some of the commands include but are not limited to operational commands, tasking commands, and health commands. In one embodiment, the operational commands may include activate, standby, takeoff, prepare to land, land, refuel, maintenance, deactivate, set flight control mode, set transport device mode, and the like. In another embodiment, the tasking commands may include fly to waypoint, hover at a location, search a location, return to base, follow an object, track an object, assess a target, engage a target, land at a location, provide a system identification, enable a joystick and the like. In another embodiment, the health commands may include system emergency, health status request, component failure, and the like.

The application program SwarmView 104 and an user interface maximize scalability to control and to monitor potentially a very large number of uninhabited heterogeneous transport devices. For example, standard graphical user interface techniques that contribute within SwarmView 104 are: hierarchical presentation of information (list/tree view of entities, command menus, notebook pages of data views), collection of applicable commands in close proximity to the entities to which they are to be applied (context menus), and the “select entities and apply commands” paradigm.

Furthermore, the application program SwarmView 104 and the user interface maximize flexibility by using simple, common communication interfaces that are independent of the generating source. For example, any type of transport device, including many that have not yet been tested, whether real or simulated, can be controlled and monitored by SwarmView 104, if the transport device system adheres to these common interfaces.

Thus, the application program SwarmView 104 includes transport device listings and enumeration (graphical and textual), multiple selection and commanding capabilities, and a rich set of transport device status and health data in multiple presentations. The graphical user interface is well designed allowing a single operator to control and monitor a large number of transport devices from SwarmView 104 without being overworked or overwhelmed. Thus, SwarmView 104 greatly simplifies and consolidates the task of operating a large number of uninhabited heterogeneous transport devices 106, 108, 110, 112.

### Exemplary Control Architecture

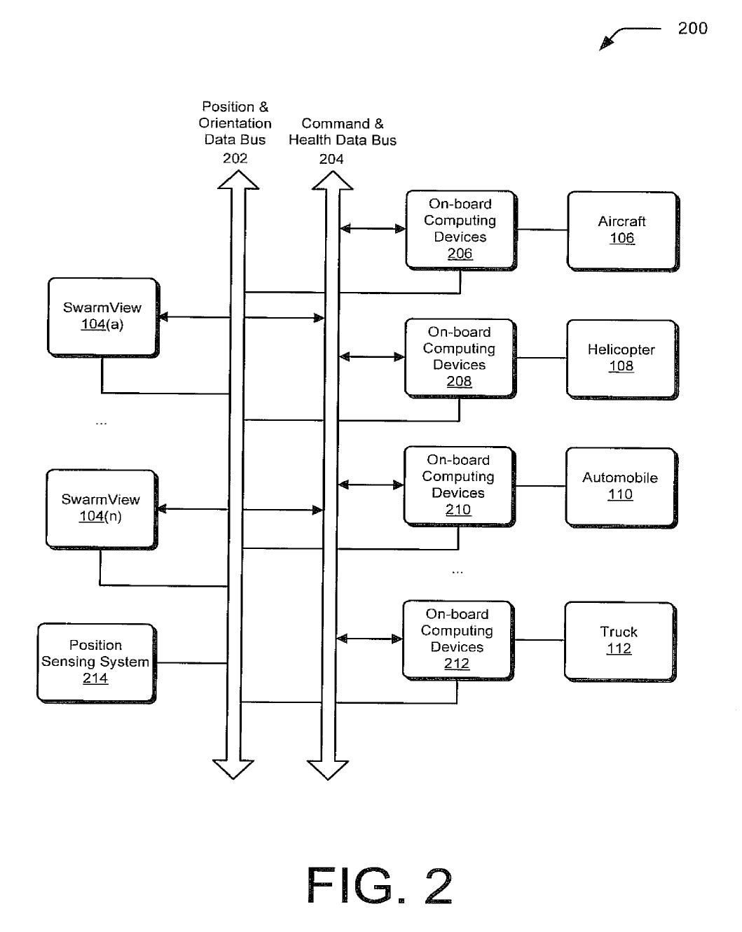

Specific embodiments will now be described in greater detail below in order to facilitate a more thorough understanding of various aspects of systems and methods in accordance with the invention. For example, FIG. 2 is a schematic view of a control architecture 200 of the operating system 100 of FIG. 1 in accordance with a particular embodiment of the invention. In this embodiment, the control architecture 200 includes an interface with a position and orientation data bus 202 and a command and health data bus 204 and is configured to perform computations and data management associated with the heterogeneous transport devices 106, 108, 110, 112. The position and orientation data bus 202 and the command and health data bus 204 interact with the control computer 102 to make full use of the capabilities of SwarmView 104.

For example, the position and orientation data bus 202 supplies position and attitude information from a VICON system for the heterogeneous transport devices 106, 108, 110, 112, real and simulated. A VICON system is a brand of Motion Capture System (MOCAP). In one embodiment, the position and orientation data bus 202 may include an IP address such as 192.168.20.xxx.

The command and health data bus 204 carries health data and control communications between the heterogeneous transport devices 106, 108, 110, 112 and various types of control and monitor application programs. In this embodiment, the control and monitor application program is SwarmView 104. In one embodiment, the command and health data bus 202 may use an IP address such as 192.168.30.xxx. Each heterogeneous transport devices 106, 108, 110, 112 communicates via a corresponding communication link.

As further shown in FIG. 2, the control architecture 200 further includes on-board computing devices 206, 208, 210, 212 for each of the heterogeneous transport devices 106, 108, 110, 112, respectively. As shown, the on-board computing devices 206, 208, 210, 212 for each of the heterogeneous transport devices 106, 108, 110, 112, respectively, operatively communicate with the position and orientation data bus 202 and the command and health data bus 204. For example, the on-board computing devices may include a navigation computer or an autoflight computer with a two-way communication interface.

The position and orientation data bus 202 is connected to a position sensing system 214, which is a motion capture system. During movement of the heterogeneous transport devices 106, 108, 110, 112, the position sensing system 214 monitors the positions and orientations of the heterogeneous transport devices 106, 108, 110, 112. In return, SwarmView 104(a) . . . 104(n) is operatively in communication with the command and health data bus 204 to provide position and orientation feedback information to the control computer 102. SwarmView 104(a) . . . 104(n) compares the position and orientation feedback information with the anticipated or desired positions and orientations of the heterogeneous transport devices 106, 108, 110, 112, and sends appropriate command signals to be transmitted to the heterogeneous transport devices 106, 108, 110, 112 via the communication links to controllably adjust (or maintain) the positions and orientations of the heterogeneous transport devices 106, 108, 110, 112 in their desired positions and orientations or their desired paths. Thus, the position sensing system 214 provides the operating system 100 with a closed-loop feedback control capability for controllably adjusting the positions and courses of movement of the heterogeneous transport devices 106, 108, 110, 112. More specifically, the position sensing system 214 may advantageously provide closed-loop feedback information that enables SwarmView 104(a) . . . 104(n) via the control computer 102 to determine and control not only positions and movements, but also attitude and stabilization control commands for proper control and stabilization of the heterogeneous transport devices 106, 108, 110, 112.

### Illustrative Process Flow

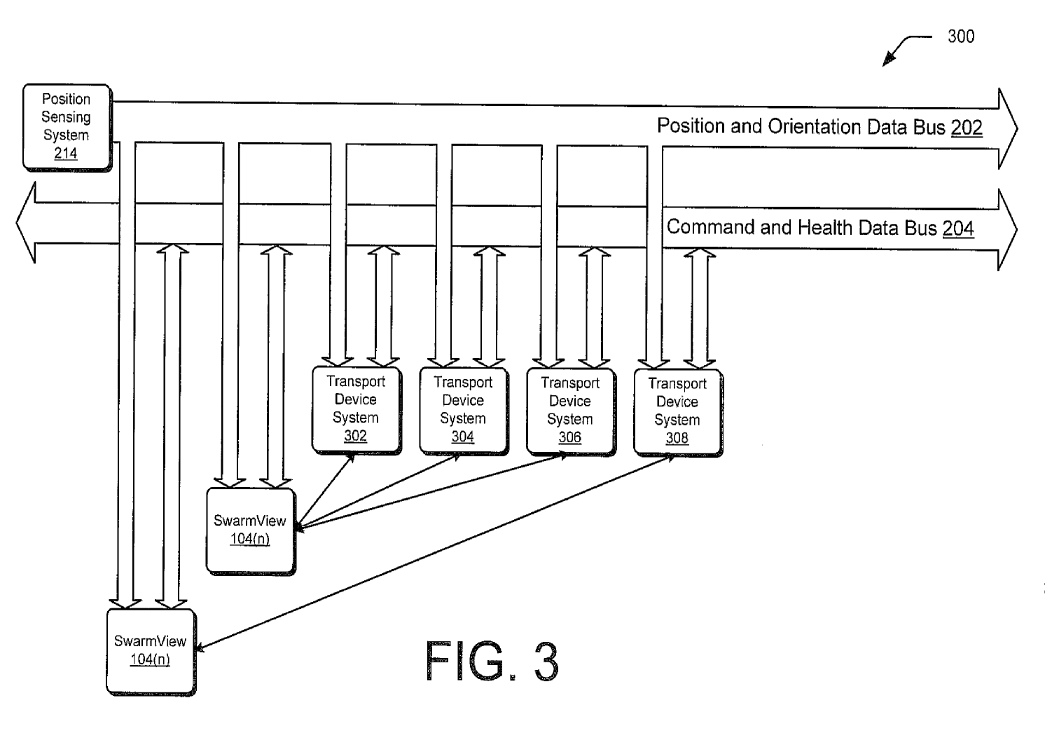

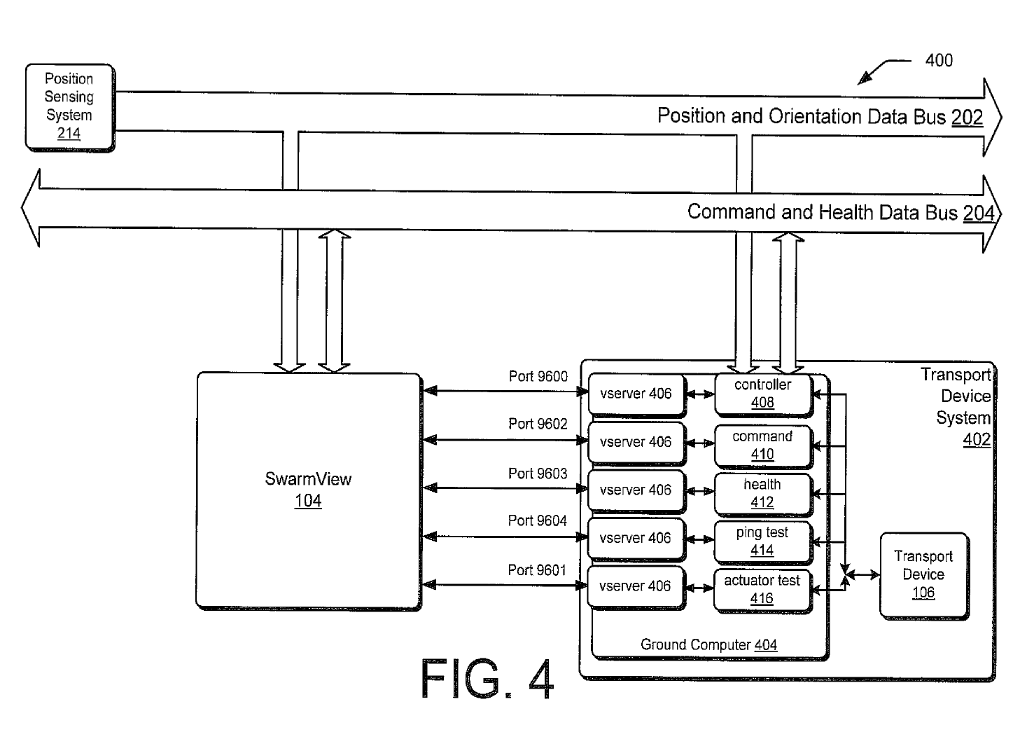

FIG. 3 and FIG. 4 illustrate schematic diagrams of an exemplary process flow in accordance with an embodiment. The exemplary overview process flow 300 and the exemplary detailed process flow 400 are shown as separate functional steps but should not be construed as necessarily order-dependent in performance. The order described is not a limitation and any number of the process steps may be combined to implement the method.

FIG. 3 illustrates an exemplary overview process flow 300. Shown are the position and orientation data bus 202 with the position sensing system 214 operatively coupled to SwarmView 104(a) . . . 104(n) and to the transport device systems 302, 304, 306, and 308, and the command and health data bus 204 operatively coupled to SwarmView 104(a) . . . 104(n) and to the heterogeneous autonomous transport device systems 302, 304, 306, and 308. The heterogeneous autonomous transport device systems 302, 304, 306, and 308 each may include an on-board computing device, a control application, a command application, a self-test application, a health test, and other applications, a connection to the client-side server, a connection to SwarmView 104(a) . . . 104(n), and the like.

In turn, the operator may monitor any desired characteristics of the system 100 that may be of interest on a situational display module of the human interface, including the positions, movements, and health characteristics of the heterogeneous transport devices 106, 108, 110, 112. For example, the operator of transport device system 306 may monitor desired characteristics (e.g. position, movement, health characteristics, etc.) on a simulated transport device display portion of SwarmView 104(a) . . . 104(n). In one embodiment, the operator may display actual path histories or display the planned tasks for the heterogeneous transport devices 106, 108, 110, 112.

In one embodiment, the operator using SwarmView 104(a) requests a client-side server daemon that is operatively coupled to the remote on-board computing device of the heterogeneous transport device to initialize or to start a transport device control application for the heterogeneous transport device. For example, the starting mechanism may be internal to the transport device system. Each of the client-side servers listens for connections that the operator requests through SwarmView 104 for a particular transport device associated with a specific name. This request by SwarmView 104 occurs by making a Transmission Control Protocol (TCP) network socket connection on a known port associated with the desired client-side server to start the desired control application.

The client-side server starts the requested application (the on-board controller application) and connects the application's standard input and output streams to a previously opened TCP socket that allows SwarmView 104(a) to interact with the transport device control application based on standard behavior. An operator using SwarmView 104(a) controls the remote transport device control application through the standard input and monitors the behavior and effects through the standard output. Thus, the transport device application controls the transport device and monitors the behavior and condition through a two-way communication. The operator sends commands and messages through the command and health data bus 204.

Once a Transmission Control Protocol (TCP) network/Internet Protocol (IP) connection is established, the operator using SwarmView 104 may have simple direct control of the on-board computers through a point-and-click selection and one-button actions. In one embodiment, the operator selects a transport device and uses a “rubber-band” line to define the transport device's planned path. SwarmView 104 allows the operator to left-click at a desired task location. In another embodiment, the operator selects multiple transport devices, displaying mission plans sequentially for each of the transport device. SwarmView 104 allows the operator to add new tasks or to delete selected tasks using one-button actions.

In another embodiment, the operator using SwarmView 104(n) may issue control commands to various components of the transport device system 302 via a control module of the human interface. Initially, the transport device system 302 starts a transport device, connects with the client-side server, and connects with SwarmView 104(n) through a TCP connection. For example, the operator may transmit appropriate commands on SwarmView 104(n) to the transport device system 302. In this embodiment, there is one operator that can direct one or more heterogeneous transport device systems, such as 302, 304, 306.

In another embodiment, there may be two or more operators using SwarmView 104(a), 104(n) on different computing devices at various locations that have access to the same heterogeneous transport devices. In this instance, there is an indicator that would give higher authority or priority to one version of SwarmView 104 or to a chosen operator to send commands to the transport devices. Thus, the commands sent by this version of SwarmView 104(a) or the chosen operator would override other commands, if issued at the same time by the other operator or other version of SwarmView 104(n). In one embodiment, the first human operator may take priority over the second human operator based on a personal identification number, a password, a thumb print, an employee badge number, a voice-activation, and the like.

In another embodiment, an operator may issue control commands to various components of the transport device systems 303, 304, 306, 308 via a control module of the human interface on SwarmView 104(a) . . . 104(n), which operatively communicates with the position and orientation data bus 202 and with the command and health data bus 204. For example, an operator may transmit appropriate commands on SwarmView 104(n) to the transport device system 302 to direct the movement, attitude, activity, or any other desired characteristic of the transport device via the position and orientation data bus 202. In response, the on-board computing devices of the one or more heterogeneous transport devices send feedback via the command and health data bus 204.

FIG. 4 is a schematic view of an exemplary process flow 400 in accordance with an embodiment of the invention. In one embodiment, the transport device system 402 includes a ground computer 404 (also referred to as a client-side server). The ground computer 404 includes an application program, known as vserver 406, operating on each of the on-board computing devices of the transport devices. The vserver 406 is a startup daemon, which listens continuously for TCP connections on a set of specified ports, one port for each remote program to be controlled. When a connection is received from SwarmView 104, the program associated with a particular port is started on the on-board computing device.

Shown is one embodiment where the transport device 106 is activated and the transport device 106 is connected to the ground computer 404. The operator using SwarmView 104 connects to a vserver 406 of the ground computer 404 using a direct TCP connection 9600. The vserver 406 starts a program, controller 408, associated with the particular TCP connection 9600 on the on-board computing devices. Through this activation, vserver 406 connects the standard input and standard output to the TCP port 9600. Now SwarmView 104 can interact directly with the controller 408 based on a standard behavior, such as reading and writing standard input and output. The operator using SwarmView 104 may send messages to the transport device 106 through the command and health data bus 204. When the TCP connection is terminated, vserver automatically ends the on-board computing device control program. Through this method, SwarmView 104 can start, stop, and control the operations of the application programs for the on-board computing devices using simple and minimal operator inputs.

The control computer 102 through SwarmView 104 is configured to receive video and sensor signals, commands 410, health monitoring signals 412, and to transmit appropriate command signals to the transport device system 402. SwarmView 104 is implemented on the control computer 102 to perform a variety of functions associated with monitoring and controlling the transport device system 402 and the various components of the system 100. Alternately, the control computer 102 may include one or more programmable hardware components configured to perform one or more of these functions.

In another embodiment, the operator using SwarmView 104 connects to the ground computer 404 using direct TCP connections 9600, 9602, 9603, 9604, 9601, to vserver 406. The diagram illustrates a one to one relationship which gives authority for the transport device system 402 to SwarmView 104. The vserver 406 starts a controller 408, a command 410, a health 412, a ping test 414, and an actuator test 416 and connects the standard input and standard output to these TCP ports. Thus SwarmView 104 may interact with the controller 408, the command 410, the health 412, the ping test 414, and the actuator test 416 based on standard behavior.

In an embodiment, the program, controller 408, tells vserver 406 to run the control application program on the on-board computing devices of the transport devices and the program command 410, tells vserver 406 to run commands on the specified on-board computing device on behalf of the selected one or more transport devices. In another embodiment, the program, health 412, tells vserver 406 to collect current parameter states, to collect information for health graphs, and to collect status information. In another embodiment, the program, ping test 414, tells vserver 406 to operate on the on-board computing devices to dynamically-update ping statistics over the last 50 samples. In an embodiment, the program, actuator test 416, tells vserver 406 to test communications with and proper operation of the selected one or more transport devices.

### Health and Status Graph Information

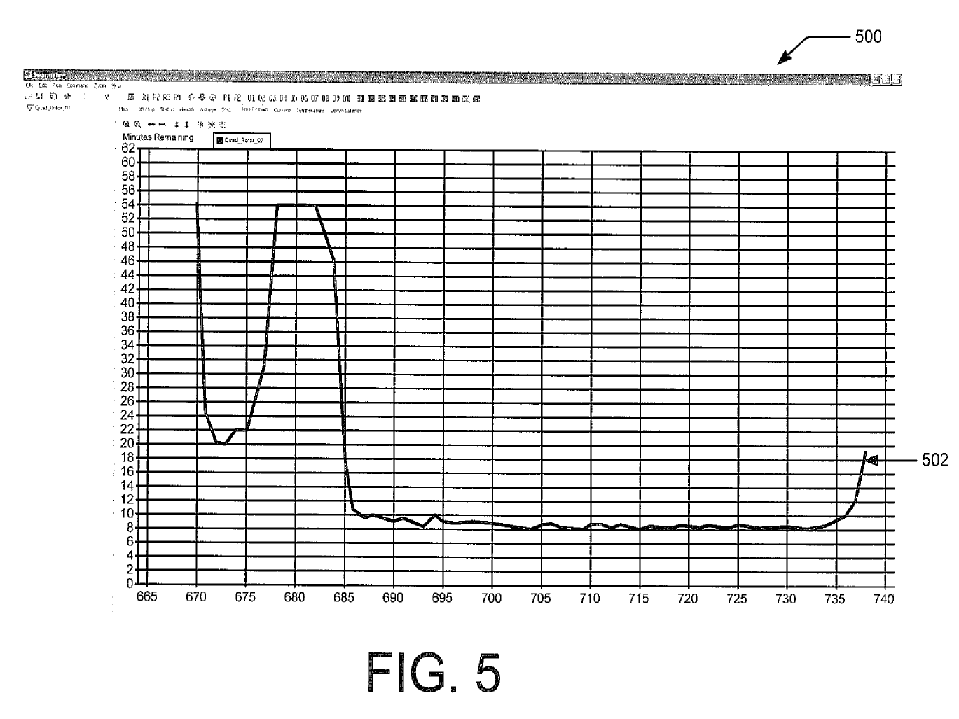

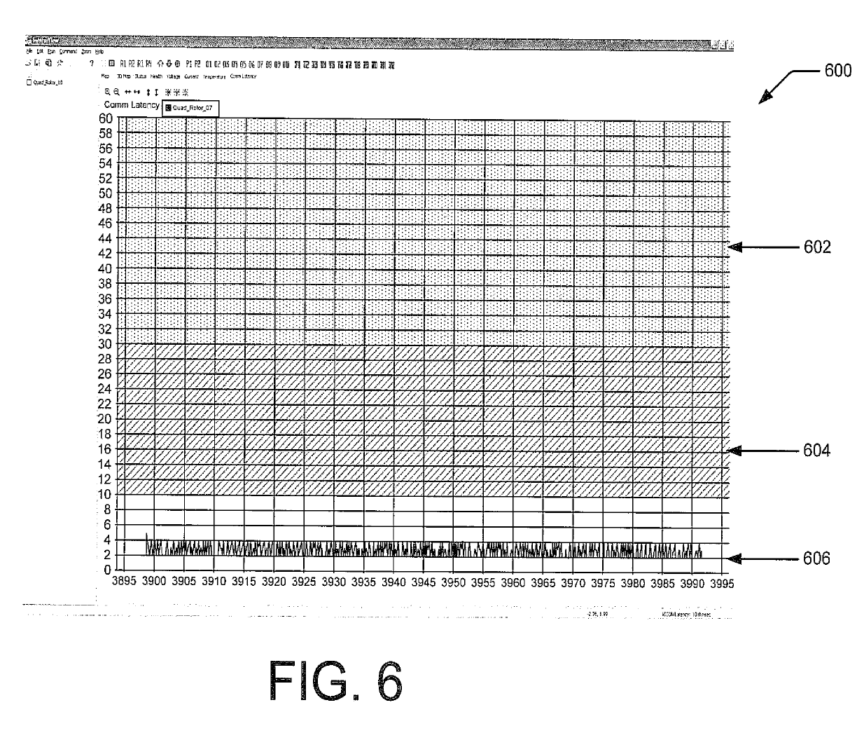

FIG. 5 and FIG. 6 are schematic views of exemplary health and state graphs 500, 600 in accordance with an embodiment of the invention. The graphs have a title in an upper-left side, a legend to a right of the title, a horizontal axis that measures time in seconds, and a vertical axis that is appropriate engineering units for the quantity being displayed.

The health and state information may include but is not limited to, status, name of transport device, identification of transport device, communication system safety check enabled, voltage safety, gyros, average current, average temperature, voltage measured, voltage estimated, battery out of state, time remaining, and latency.

The health monitoring data transmitted by the onboard sensors, are compared with predicted and desired data values. For example, the measured positions, attitudes, and velocities of the transport device may be compared with desired values based on a pre-programmed mission profile stored within the control computer 102. Similarly, transport device health data, such as battery charge levels, fuel levels, pressure and temperature levels, weapons status, other expendable resource levels, and any other desired health parameters may be compared with anticipated or desired values based on the pre-programmed mission profile.

In one embodiment, a determination (or series of determinations) is made to determine whether health conditions of the one or more transport devices are unacceptable. If so, the system 100 determines whether the unacceptable health condition is correctable. If so, then corrective action may be taken to adjust the efficient health conditions of the one more transport devices, including using the health condition as a constraint in the control commands of the corresponding transport devices. If the health conditions of the transport devices are not unacceptable, or if any unacceptable conditions are not correctable, a determination is made regarding whether the test or mission is complete. If not, the system returns to whether command signals are communicated and the above-described actions are repeated. Otherwise, the method is complete.

FIG. 5 is a schematic view of an exemplary health and state graph 500 in accordance with an embodiment of the invention. A screen displays graph 500 illustrating an estimate of a number of minutes remaining on a battery at the current rate of discharge. The behavior for this graph is the same whether there is one transport device selected or multiple transport devices, one line is plotted for the remaining number of minutes remaining 502.

FIG. 6 is a schematic view of exemplary health and state graph 600 in accordance with an embodiment of the invention. A screen displays graph 600 illustrating a communication latency range. For example, the region 602 indicates a cutoff for a “Comm. Error” and the region 604 indicates a “Comm. Warning”. The behavior for this graph is the same whether there is one transport device selected or multiple transport devices, one line is plotted for the communication latency for each of the selected transport devices 606.

### Exemplary Map View

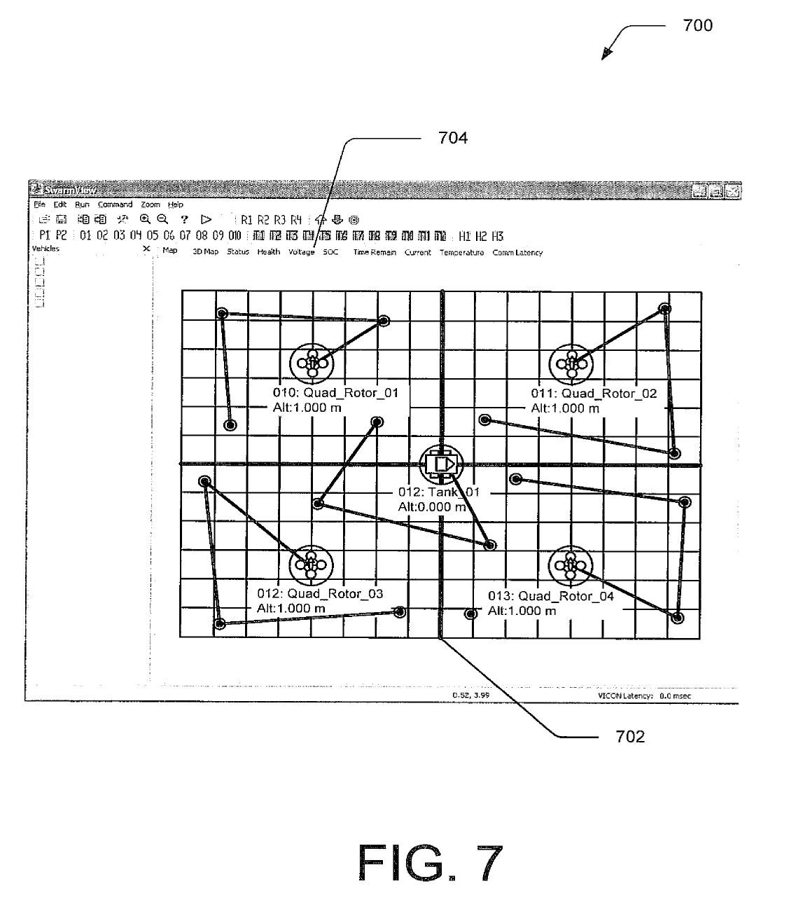

FIG. 7 is a schematic view of an exemplary map view 700 in accordance with an embodiment of the invention. The map view 700 shows a top-down view of the transport devices provided by the VICON position sensing system within the operator-defined space and with over-laid grid-lines at operator defined intervals. The current position in meters of a mouse pointer within the map view is indicated dynamically in a middle section of a status bar at a bottom of a main window 702. Menu descriptions and various messages to the operator are displayed in a left-most status bar section 704. For example, the descriptions may include map, 3D map, status, health, voltage, current, temperature and comm. latency 704.

The operator may select a transport device, which makes the menu and toolbar options available. Alternatively, the operator may select several transport devices by clicking on each individually while holding down the CTRL or SHIFT key during selection. Panning and zooming are possible using map view 700.

### Exemplary Computing Environment

FIG. 8 is a block diagram of an exemplary general operating environment 800 for computer-readable storage media to control one or more heterogeneous transport devices. The environment may be configured as any suitable control computer 802 capable of implementing the application program, SwarmView 104. In one exemplary configuration, the control computer 802 comprises at least one processor 804 and memory 806. Depending on the configuration and type of control computer 802, memory 806 may be volatile (such as RAM) and/or non-volatile (such as ROM, flash memory, etc.).

Memory 806 can store programs executed on the processor 804 and data generated during their execution. It may store any number of programs, data, including an operating system, one or more application programs, other program modules, and program data.

Memory 806 may include an operating system 808, one or more application programs 810 for implementing SwarmView 104, as well as various other data, programs, media, and the like. In an embodiment, the memory 806 includes SwarmView 104, including a program module, 812, a user interface module 814, and a data management module 816.

The program module 812 may include process modules (not shown) that realize one or more of the processes described, implemented as part of the operating system 808, or installed on the computing device and stored in other memory separate from the system memory 806. The user interface module 814 presents the user with a graphical user interface for sensing and measuring of position of the transport devices, including an interface prompting an operator to respond to status and health information. The data management module 816 manages storage of information, such as position, attitude, health and status information, and the like, and may communicate with one or more local and/or remote data bases such as historical status and health information.

Memory 806 can also include various computer-readable storage media. It will be understood that volatile memory may include media such as random access memory (RAM), non volatile memory may include read only memory (ROM) and flash portion. The computing environment 800 may also include other removable/non-removable, volatile/non-volatile computer storage media such as a hard disk drive for reading from and writing to a non-removable, non-volatile magnetic media, a magnetic disk drive for reading from and writing to a removable, non-volatile magnetic disk (e.g., a “floppy disk”), and an optical disk drive for reading from and/or writing to a removable, non-volatile optical disk such as a CD-ROM, DVD-ROM, or other optical media. The disk drives and their associated computer-readable media can provide non-volatile storage of computer readable instructions, data, program modules, and other information for the control computer 802.

The control computer 802 may also contain communications connection(s) 818 that allow the control computer 802 to communicate with a database, and/or other devices on a network. Communications connection(s) 818 is an example of communication media. The communications connections 818 include the two network adapters, one for position and orientation bus 202 and one for command and health data bus 204. Communication media typically embodies computer readable instructions, data, program modules, or other information and includes any information delivery media. By way of example, and not limitation, communication media includes wired media such as a wired network or direct-wired connection, and wireless media such as acoustic, RF, infrared and other wireless media. The term computer readable media as used herein includes both storage media and communication media.

The control computer 802 may also include but is not limited, to input device(s) 820, such as a keyboard, a mouse, a stylus-based device, a control stick, a joystick, a control yoke, and the like. The control computer 802 may include output devices 822, such as a display screen, speakers, and the like. All these devices are well known in the art and need not be discussed at length here.

The subject matter described above can be implemented in hardware, or software, or in a combination of both hardware and software. Although the subject matter has been described in language specific to structural features and/or methodological acts, it is to be understood that the subject matter defined in the appended claims is not necessarily limited to the specific features or acts. While specific embodiments of the invention have been illustrated and described herein, as noted above, many changes can be made without departing from the spirit and scope of the invention. Accordingly, the scope of the invention should not be limited by the disclosure of the specific embodiments set forth above. Instead, the invention should be determined entirely by reference to the claims that follow.

What is claimed is:

1. A method for controlling one or more heterogeneous transport devices comprising:
generating a command signal from a control computing device for the one or more heterogeneous transport devices based on capabilities of each transport device and requirements of a mission; and
transmitting the command signal to control on-board computing devices of the one or more heterogeneous transport devices to execute the requirements of the mission.

2. The method of claim 1, wherein
generating the command signal comprises the control computing device operatively coupled to at least one communication network and configured to compute the command signal; and
transmitting the command signal comprises transmitting via at least one communication network from the control computing device to a client-side server configured to receive the command signal.

3. The method of claim 2, wherein transmitting the command signal to the client-side server uses connections of a Transmission Control Protocol (TCP)/an Internet Protocol (IP).

4. The method of claim 1, wherein generating the command signal comprises initiating and providing Command and Control and Health Monitoring (CCHM) on the control computing device.

5. The method of claim 1, further comprising receiving operating and health monitoring information from the one or more heterogeneous transport devices and assessing a status and a health condition of the one or more heterogeneous transport devices based on the received health monitoring information.

6. The method of claim 1, further comprising receiving feedback from the one or more heterogeneous transport devices based on a response to the command signal.

7. The method of claim 1, further comprising receiving information from the one or more heterogeneous transport devices based on a status, a position, an orientation, or an attitude of the one more heterogeneous transport devices.

8. The method of claim 1, further comprising generating the command signal from a first control computing device and a second control computing device operatively coupled to at least one communication network and configured to compute the command signal, wherein the first control computing device has priority in generating the command signal over the second control computing device.

9. The method of claim 1, further comprising transceivers located at each end of a communication link.

10. A computer-readable storage media including computer-program instructions executable by a computing device, the instructions configured to cause the computing device to perform operations comprising:
generating a command signal for one or more heterogeneous transport devices based on capabilities of each transport device and requirements of a mission;
transmitting the command signal to control on-board computing devices of the one or more heterogeneous transport devices to execute the requirements of the mission; and
receiving feedback from the on-board computing devices of the one or more heterogeneous transport devices based on a response to the command signal.

11. The computer-readable storage media of claim 10, wherein
generating the command signal comprises initiating and providing Control and Health Monitoring (CCHM) on the control computing device; and
transmitting the command signal comprises identifying the one or more heterogeneous transport devices based on a name of a transport device, an internet protocol (IP) address associated with the name of a transport device, or an identification number for a transport device.

12. The computer-readable storage media of claim 10, further comprising receiving operating and health monitoring information from the one or more heterogeneous transport devices and assessing a status and a health condition of the one or more heterogeneous transport devices based on the received health monitoring information.

13. The computer-readable storage media of claim 12, further comprising displaying the status and the health conditions of the one or more heterogeneous transport devices in graphs.

14. The computer-readable storage media of claim 10, further comprising receiving information from the one or more heterogeneous transport devices based on a position, an orientation, or an attitude of the one more heterogeneous transport devices.

15. The computer-readable storage media of claim 10, further comprising shutting down the one or more heterogeneous transport devices when at least one representation occurs due to a failure alert, a control signal is invalid, a command fails, or a connection is not active to a client-side server.

16. The computer-readable storage media of claim 10, further comprising generating the command signal from a first control computing device and a second control computing device operatively coupled to at least one communication network and configured to compute the command signal, wherein the first control computing device has priority in generating the command signal over the second control computing device.

17. A system for controlling one or more heterogeneous transport devices, the system comprising:
memory;
a processor coupled to the memory configured to perform operations;
a control architecture configured to generate a command signal from a control computing device for the one or more heterogeneous transport devices based on capabilities of each transport device and requirements of a mission;
the control architecture configured to transmit the command signal to control on-board computing devices of the one or more heterogeneous transport devices to execute the requirements of the mission; and
the control architecture configured to receive feedback from the on-board computing devices of the one or more heterogeneous transport devices based on a response to the command signal.

18. The system of claim 17, wherein the control architecture includes a health monitoring component configured to receive health monitoring information from the one or more heterogeneous transport devices, and to assess a health condition of the one or more heterogeneous transport devices based on the received health monitoring information, the control architecture being further configured to determine a corresponding command signal based at least partially on the health monitoring information of the one or more heterogeneous transport devices.

19. The system of claim 17, wherein the control architecture includes:
at least one communication network operatively coupled to a position sensing system;
a main processing component operatively coupled to the at least one communication network and configured to compute the command signals; and
one or more control modules operatively coupled to the at least one communication network and configured to receive the command signals from the main processing component, to transmit the command signals into a format suitable for use by the on-board computing devices of the one or more heterogeneous transport devices, and to transmit the command signals to the one or more heterogeneous transport devices.

20. The system of claim 17, wherein the control architecture includes:
a communication component configured to receive a position and an attitude from a position sensing system and a status and a health monitoring information from a health monitoring component; and
an onboard processing component positioned on each of the one or more heterogeneous transport devices and configured to send the position and the attitude of the one or more heterogeneous transport devices, the onboard processing component being further configured to receive the command signals and to communicate the command signals to an onboard control system of each of the transport devices.
